(19) United States
(12) Patent Application Publication
(10) Pub. No.: US 2008/0191048 A1
(43) Pub. Date: Aug. 14, 2008

(54) Connecting device for layout elements in model train

(76) Inventor: Tatsuo Iwasawa, Tokyo (JP)

Correspondence Address: JACOBSON HOLMAN PLLC, 400 SEVENTH STREET N.W., SUITE 600, WASHINGTON, DC, 20004, US

(21) Appl. No.: 11/826,742

(22) Filed: Jul. 18, 2007

(30) Foreign Application Priority Data
Feb. 9, 2007 (JP) 2007-030908

(51) Int. Cl. B60M 5/00

(52) U.S. Cl. 238/14.14

(57) ABSTRACT

Provided is a model train, which can be disassembled, when not used, into the size of one layout element but can be extended, when used, to a size according to a space. In the model train, rail elements including straight, curved and terminal ones are laid on layout bases to form layout elements, and the layout elements are connected to constitute predetermined running lines. The layout elements 11, 12 and 13 are provided at their connecting end portions 14, 15, 16 and 17 with at least one mechanical joint means composed of a recess 19 and a protrusion 18, which can fit each other thereby to constitute a layout, in which the layout elements are mechanically jointed and integrated by the aforementioned joint means. Rail elements 21 and 22 are connected by rail connecting means disposed at a predetermined position of the layout elements, and the layout elements are jointed by the aforementioned joint means so that the rail elements are also electrically connected with each other.

### BACKGROUND OF THE INVENTION

1. Field of the Invention

The present invention relates to an element connecting device of a model train layout, in which rail elements including various shapes are laid on a layout base to form layout elements and in which the layout elements are connected to constitute a predetermined running line.

2. Background Art

The layout of the model train is one, in which rails are arranged on the base so that a model train or the like may run, or in which railway scenes are disposed around the rails. An enthusiast for the model train cannot always use a wide space, even he or she intends to realize a layout of variations. In case the model train is placed on each occasion in a living room or the like, the larger layout invites the more serious troubles. From these circumstances, a layout of folding or assembling type is desired in the model train. In case one layout is formed by connecting its elements, the positioning of the portions to be connected has to be considerably precise for connecting the layout elements electrically.

In Japanese Utility Model Registration No. 3,024,398, for example, a track bed having metal rails for feeding electricity is provided with an embracing portion, into which the end portion of a rail flange is inserted, and in which a small contact plate capable of connecting both rails electrically is disposed. This constitution connects the metal rails directly with each other, but the connecting relation to a power source circuit is not disclosed. On the other hand, Japanese Utility Model Registration No. 3,099,959 relates to a foldable/expandable book type model train layout device. The invention described therein discloses a constitution, in which separate rails are electrically powered with conductors such as jumper line, but not the connecting relations to the power source circuit. In case the power is not properly fed from the power source circuit to the rails, there arise problems that the smooth run of the model train is deteriorated, and that the actions of accessory facilities are troubled.

Moreover, the invention of Japanese Utility Model Registration No. 3,099,959 is based on the concept, in which the layout base is folded in an open/close manner like a book, and is constituted such that the surface and the back are hinged by the spine. This folding structure always needs the considerable portions corresponding to the surface, back and spine. Since the weight of a layout base is unchanged before and after folded, it is thought that the size enlargement is limited. For the usable state, moreover, the necessary space has to be sufficient for extending the entire layout. Therefore, the layout base cannot be used in the place where it cannot be extended.

### [Patent Document 1]

Japanese Utility Model Registration No. 3,024,398

### [Patent Document 2]

Japanese Utility Model Registration No. 3,099,959

### SUMMARY OF THE INVENTION

The invention has been conceived in view of the aforementioned points, and has an object to provide a model train, which can be disassembled to a size of about one of layout elements and extended, when used, to a size according to the space.

Another object of the invention is to provide a model train, which is composed of a plurality of layout elements, which can be jointed and separated easily and reliably and which can be mechanically to ensure the electric connections at electric portions including rails. In short, the invention provides a connecting device for layout elements in a model train, which can joint and disassemble the layout elements rationally when the layout is to be expanded or developed according to the margin of space or the allowance for infusion of costs.

In order to solve the aforementioned problems, according to the invention, in a layout of a model train, in which rail elements including straight, curved and terminal elements are laid on layout bases to form layout elements, arid in which the layout elements are connected to constitute a predetermined running line, there is provided a connecting device (according to the invention of claim 1) for the layout elements in the model train, characterized:

in that a layout integrated by mechanical joint means composed of mutually fitting recess and protrusion is constituted at the connecting end portions of the layout elements; and

in that the rail elements are connected by rail connecting means disposed at a predetermined position of the layout elements whereas the layout elements are jointed by said joint means so that the rail elements are also electrically connected with each other.

In the invention, the layout elements are called those, in which rail elements are laid on the layout base. The rail elements contain portions corresponding rails and track beds, and the rails contain not only straight lines and all kinds of curves but also terminals such as railroad spurs, at which the rails terminate. The portion corresponding to the track bed can have either a structure integral with the layout bed or a separate structure, in which the track bed is a member independent from the layout bed and attached together with the rails. The straight and curved rails can be freely combined and arranged on the layout bed thereby to lay the desired running lines. Moreover, the rail elements to be positioned at the connecting end portions of the layout elements are arranged at positions according to the system, as will be described hereinafter.

The connecting end portions of the layout elements are provided with at least one mechanical joint means composed of a protrusion and a recess, which can fit each other. The connecting end portion can be set at an arbitrary end of the aforementioned layout base. In a rectangular layout base, for example, one to all of the four sides can be set as the connecting end portion for mounting the aforementioned joint means. This mechanical joint means is desired to be disposed, as means for jointing the layout elements mechanically to constitute an integrated layout, at a plurality of portions of each connecting end portion.

The mechanical joint means of the layout elements can be constituted (according to the invention of claim 2) to include: protrusions shaped to protrude with a size equal to or larger than a rail spacing (i.e., a track width) from the connecting end portions of the plural layout elements; recesses shaped to fit said protrusions; and engaging portions on the side faces of said protrusions and said recesses for engaging with each other at the fitting time of said joint means thereby to prevent the fitting engagements from being released. The one protrusion of the aforementioned joint means has a structure shaped to protrude with a size equal to or larger than the rail spacing (i.e., a track width) from the connecting end portions of the layout elements. As a result, the protrusion is substantially enclosed planarly by the connecting end portion of the rail element so that a protecting effect can be obtained to prevent the collision or deformation.

It is desired (according to the invention of claim 3) that the protrusions shaped to protrude from the connecting end portions and the recesses shaped to fit said protrusions are formed in each of lines constituted of a double track. Specifically, it is desired that one of two single-track rails constituting a double track is equipped with the protrusion having the protruding structure, and that the other of the two single-track rails constituting the same double track is equipped with the recess having an enclosure structure capable of fitting the protrusion.

The mechanical joint means joints the layout elements to each other with the fitting structure, which includes the protrusion having a protruding structure, and the recess having an enclosing structure for fitting the protrusion. Further included are engaging portions, which are disposed on the sides of the protruding structure and the enclosing structure thereby to engage with each other at the fitting time of the aforementioned fitting means to prevent the release of the fitting structure. The engaging portions function as release preventing means, i.e., a disengagement stopper for the fitting structure composed of the protrusion and the recess.

The rail elements are so connected by the rail connecting means disposed at a predetermined position of the layout elements as allow the model train to run. In the invention, moreover, the rail elements are electrically connected when the layout elements are jointed by the aforementioned joint means. The rail connecting means for the rail elements is desirably given a structure, in which the connecting end portions of the rails constituting the single track are brought to abut against each other. For the electric connections, connection terminals are desirably used together and connected in a point contact or a line contact with each other.

It is desired that the mechanical joint means for the layout elements and the rail connecting means for the rail elements are overlapped at the common positions of the layout elements. By overlapping the aforementioned joint means for the layout elements and the rail connecting means of the rail elements at the common positions, the constitution, in which the rail elements are electrically connected by jointing the layout elements, can be best achieved. This constitution is important in the invention for achieving the purpose of expand and develop the layout.

According to the invention, in a model train including: a plurality of layout elements; mechanical joint means for combining the layout elements integrally to connecting the individual layout elements; and electric connecting means for the conductive portions containing rails of the layout elements electrically, a connecting device (according to the invention of claim 4) for layout elements in a model train, characterized: in that each of the layout elements includes such a pair of joint units as said joint means as are disposed at the individual connecting end portions and as can be jointed to and separated from each other; and in that the joint units are provided with: engaging portions and engaging partners adapted to be connected by causing the layout elements to engage with each other; protrusions and recesses enabled to be fitted for positioning; and relief portions for allowing the relief of the protrusions fitted in the recesses, so that the engaging portions and the engaging partners may leave each other, by turning to fold, when the joint units are in the jointed state, the end portions of one of the layout elements on the connected portions with respect to the other layout element.

The connecting device for the layout elements in the model train according to the invention is disposed at the connecting end portions of the plural layout elements. These layout elements are provided with the mechanical joint means for combining the layout elements integrally, and the electric connecting means for electrically connecting the electric portions including the rails of the plural layout elements. The mechanical joint means is means for combining the layout elements literally with each other to form an integral layout. On the other hand, the electric connecting means feeds the electric power to either the electric portions including the rails of the jointed layout element entirety or another electric circuit.

The connecting end portion of each layout element is equipped with a pair of joint units, which can be jointed to and separated from each other. The joint unit is equipped with an engaging portion and an engaging partner for engaging with each other so that the layout elements may be connected by bringing their connecting end portions into abutment against each other, and the protrusion and the recess for fitting each other for the positioning purpose. The joint unit is the mechanical joint means in the invention, the engaging portion and the engaging partner bear the jointing function mainly whereas the protrusion and the recess bear the positioning function mainly. The specific shapes and structures of the engaging portion and the engaging partner, and the protrusion and the recess can be arbitrarily designed according to the individual requirements for the engagement and the positioning.

The relief portions for allowing the relief of the protrusions fitted in the recesses are provided so that the engaging portions and the engaging partners may leave each other, by turning to fold, when the joint units are in the jointed state, the end portions of one of the layout elements on the connected portions with respect to the other layout element. The layout elements are used with the joint unit being joined, and have substantially planar surfaces when the joint unit is in the jointed state. When the individual layout elements are disassembled from the jointed state, they are not merely separated from each other but are folded on the connected portions, and the protrusion and the recess are separated by turning the layout elements to lift their end portions, thereby to facilitate the disassembly of the layout elements drastically.

For this purpose, there are provided the relief portions for allowing or warranting the relief of the protrusions to become the folding center. It is desired (according to the invention of claim 5) that the relief portions are either cavities forming the recesses fitting the protrusions and having their upper and lower and right and left portions (i.e., the whole circumference) partially removed, or elastic members having their upper and lower and right and left portions (i.e., the whole circumference) made elastically deformable. According to this construction, the release of the fitting of the protrusion and the recess is facilitated at the time of the disassembly while the protrusion and the recess serve the positioning function.

In the device according to the invention, an upper electric portion having the rails is disposed over the layout element, and a lower electric portion including circuit lines is arranged below the aforementioned electric portion of the layout element, and connecting portions are individually arranged on the sides of the upper electric portion and the lower electric portion. The electric portions are portions for controlling the power feed in the invention, and are exemplified by the rails, a third track, an overhead line or another electric portion, which is arranged over the layout elements. On the other hand, the circuit lines are arranged below the electric portions of the layout elements, and may be accepted to have the same meaning as that of a power source circuit. The connecting portions are composed of those arranged in the electric portions such as the rails, or the electric portions arranged in the circuit lines. The connecting portions need not be a special material, but the rails may be partially employed as the connecting portions. For example, an intermediate electric material made of a conductor and having elasticity can be interposed as the intermediate electric portions, which contact at their upper ends from below with the connecting portions of the upper electric portions and at their lower ends from above with the connecting portions of the lower electric means (according to the invention of claim 6).

By using the intermediate electric material made of a conductor and having elasticity, the connecting portions of the upper electric portions and the connecting portions of the lower electric portions contact under pressure so that the electric connections are ensured. The intermediate electric portions can be exemplified by either coils of wound conductors for generating pressing forces in the vertical direction, or conductive members for generating pressing forces in the transverse direction.

According to the constitution, in which the intermediate electric material are interposed in the compression state between the connecting portions of the upper electric portions and the connecting portions of the lower electric portions, as described above, the reliable electric connections can be ensured by the contact pressures. This leads to an advantage that influences are hardly received even if the positions of the intermediate electric portions and the positions of the connecting portions of the electric portions or the connecting portions of the circuit wires are deviated. This advantage leads to a prominent effect in the following case. Specifically, the upper engaging portions are the rails, and these rails are made movable together with the joint units relative to the layout elements. This raises an advantage that the connecting portions of the engaging portions slide relative to the intermediate electric portions thereby to keep the electric connections.

The connecting device for the layout elements in the model train of the invention uses the layout elements in combination with the connecting means, but the individual layout elements themselves need not have the constitution to enable the model train to run. However, either the individual layout elements or one of the layout elements can be constituted to enable the model train to run. This constitution enabling the model train to run may include predetermined rails and circuit functions to power the model train on the rails.

According to the invention thus constituted to act, the layout elements can be removed, when unused, and disassembled to the size of one layout element, but can be extended, when used, to the size according to the space. The layout elements can be easily jointed and disassembled to afford convenient storages and using conveniences. In the invention, moreover, the layout can be extended or developed according to the space and cost allowed. In the case of the Z-gauge or N-gauge, for example, the model train can be used on a small table or can be extended all over a room. According to the invention, another advantage is that the individual layout elements can be jointed and separated easily and reliably.

### BRIEF DESCRIPTION OF THE DRAWINGS

FIG. 1 is a perspective view showing Embodiment 1 of a connecting device for layout elements in a model train according to the invention;

FIG. 2 is a perspective view showing Embodiment 2 of the same;

FIG. 3 is a top plan view showing one example of a rail element to be used in Embodiment 1 and Embodiment 2;

FIG. 4 is a front elevation of the rail element of FIG. 3;

FIG. 5 presents side elevations also showing the rail element at A before connected and at B after connected;

FIG. 6 is a bottom view showing one example of the rail element;

FIG. 7 is also a bottom view showing the connected state of the same;

FIG. 8 is a perspective explanatory view also showing the rail element;

FIG. 9 shows one example of an electric connecting portion, and presents perspective views of connection terminals at A and B, an explanatory view showing one example of an electric conduction portion to the rails at C, and an explanatory view showing one example of mechanical joint means at D;

FIG. 10 is an exploded perspective view showing Embodiment 3 of the connecting device for the layout elements in the model train according to the invention;

FIG. 11 is a top plan view showing one example of a joint unit to be used in the aforementioned device;

FIG. 12 is a bottom view showing the same one as that of FIG. 11;

FIG. 13 shows the joint unit attached to the layout elements, and presents a sectional front elevation at A and an enlarged sectional view of an essential portion at B;

FIG. 14 is an exploded perspective view showing the layout element and the joint unit;

FIG. 15 is a perspective view showing the layout element and the joint unit;

FIG. 16 is an exploded perspective view showing a modification of FIG. 14; and

FIG. 17 shows the joint and disassembly of the layout elements, and presents a sectional view showing a jointing work of the joint units at A, a sectional view showing the jointed state at B, and a sectional view showing the separated state at C.

### DESCRIPTION OF THE PREFERRED EMBODIMENTS

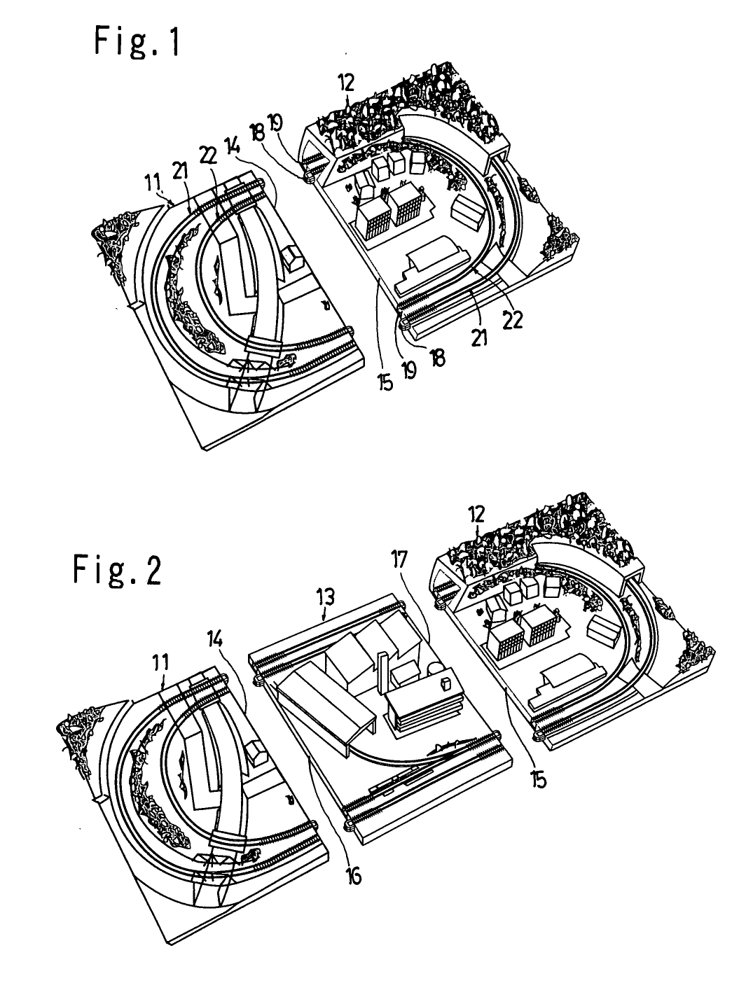

With reference to the shown modes of embodiment, a connecting device of layout elements in a model train of the invention is described in more detail. FIG. 1 shows Embodiment 1 of a model train layout of the invention, which is constituted of two layout elements 11 and 12. These layout elements 11 and 12 are the end ones, both of which can be arranged at the end portions. Moreover, FIG. 2 is an entire diagram showing Embodiment 2, in which the two layout elements 11 and 12 and an intermediate layout element 13 are combined by arranging the latter between the former two.

Rail elements 21 and 22 are arranged on the bases of the individual layout elements, and the rails are provided therearound with railway scenes S including railway facilities such as stations, maintenance factories, railroad crossings, tunnels and/or bridges, trees, buildings and so on. In Embodiment 1 and Embodiment 2, as shown, a single track composed of paired two rails and a double track composed of two parallel rows of single tracks are arranged on the layout elements 11, 12 and 13. Later-described connecting end portions 14, 15, 16 and 17 are provided with the rail elements 21 and 22 especially as the double track. Here, the planar shape of the individual layout bases themselves should not be limited to the shown rectangles but can be set to another arbitrary shape such as a semicircle or triangle.

In the cases of Embodiment 1 and Embodiment 2, the end layout elements 11 and 12 both having a rectangular planar shape are provided, only at one of their four sides, with the connecting end portions 14 and 15 to be equipped with mechanical joint means. In the case of Embodiment 2, moreover, the intermediate layout element 13 is set such that two right and left ones of the four sides of the rectangular planar shape are used as the connecting end portions 16 and 17 to be equipped with the aforementioned joint means. However, the connecting end portions can be disposed not only on the right and left sides of the planar shape of each of the layout elements 11 to 13 but also in front and at the back. Therefore, the model train layout according to the invention can be extended not only transversely, as in Embodiment 1 and Embodiment 2, but also longitudinally. As a result, the layout elements 11, 12, 13 and so on can also be combined into a four-squared shape, an L-shape or a T-shape.

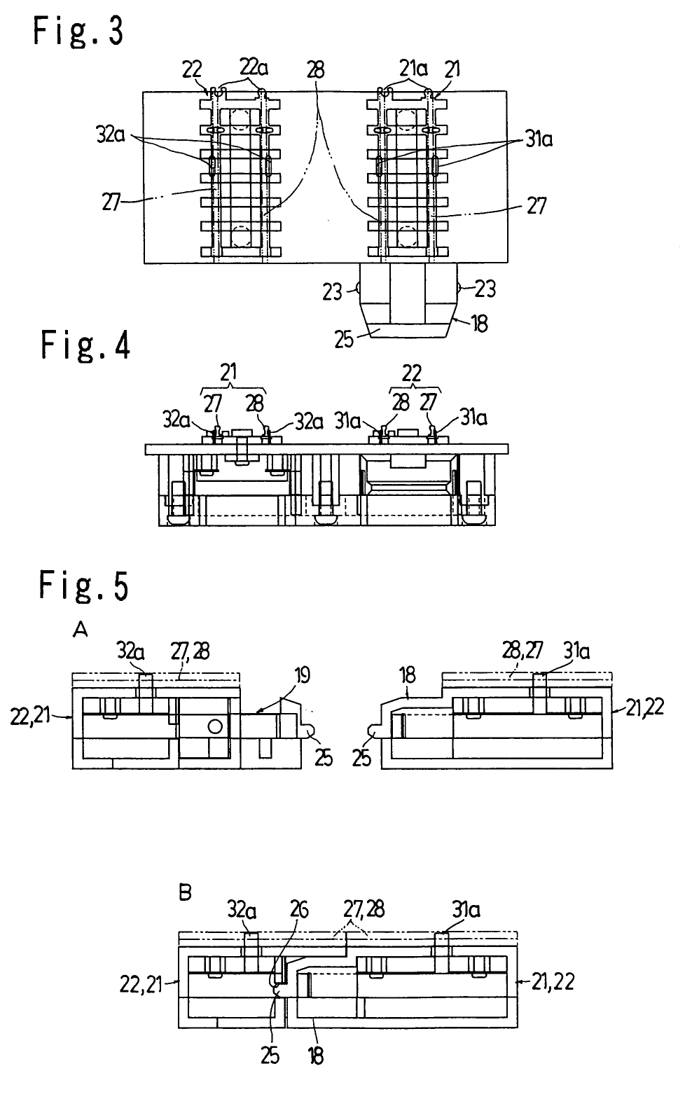

In the shown example, the aforementioned joint means of the layout elements is constituted of a protrusion 18, which has a protruding structure made wider than two rails 27 and 28 and protruding from the connecting end portions 14, 15, 16 and 17, and a recess 19, which has an enclosing structure for fitting that protrusion 18. The mechanism joint means is formed at each of the rail elements 21 and 22 constituted of a double track. Specifically, one single track constituting the double track is equipped with the protrusion 18 having the protruding structure, and the other single track constituting the same double track is equipped with the recess 19 having the enclosing structure for fitting the protrusion 18 (as referred to FIG. 3 and so on). The strength necessary for jointing and integrating the layout elements 11, 12 and 13 is exhibited by equipping each of the lines constituting the double track with the protrusion 18 having the protruding structure protruding from the connecting end portions 14, 15, 16 and 17 and the recess 19 having the enclosing structure.

Moreover, the protrusion 18 of the protruding structure and the recess 19 of the enclosing structure are formed on their side faces with engaging portions for engaging with each other at the fitting time of the mechanical joint means and for preventing the release of the fitting. The engaging portions function as fitting-release preventing means, i.e., a disengagement preventer. In the shown case, the engaging portions are equipped with protuberances 23 on the right and left side faces with respect to the fitting direction of the protrusion 18, and indentations 24 for engaging with the protuberances 23, on the right and left side faces (as referred to FIG. 3 to FIG. 9D). Moreover, the protrusion 18 is equipped with a projection 25 at its leading end of the fitting direction, and the recess 19 is equipped with a fitting portion 26 in the deepest position of the recess 19 in the fitting direction. In addition to the protrusion 18 and the protuberances 23, the fitting structures of three stages are formed so that a complete connection may be attained irrespective of precision (as referred to FIG. 5B).

The rails 27 and 28 constituting the rail elements 21 and 22 are so connected by rail connecting means disposed at predetermined positions of the layout elements 11, 12 and 13 that they enable the model train to run. For the rail connections of the shown case, there is used the structure, in which the connection end portions of the rails 27 and 28 abut against each other. For the electric connections, connection terminals 31 and 32 are used together (as referred to FIGS. 9A and 9B) These connection terminals 31 and 32 are equipped with ear members 31a and 32a, which can contact with the rails 27 and 28 of the individual rail elements 21 and 22 to feed electricity from a power source circuit to the rails 27 and 28 (as referred to FIG. 9). The rails 27 and 28 can be exemplified by commercially available ones, because they are merely made to abut against each other without any working.

In the shown example, the connection terminals 31 and 32 are so arranged on the two right and left sides of the protrusion 18 as are fixed on positioning bosses 33 and 34 disposed fixedly on the side of the layout elements. In the male side connection terminal 31, the outer side faces act as electric terminals 35. The female side connection terminal 32 is equipped with two right and left contact portions 36, which are embossed toward those connection terminals 35 thereby to clamp the right and left electric terminals 35 from the outer sides. As a result, the electric terminals 35 and the contact portions 36 can be connected by point contacts or line contacts, so that the electric feed can be retained irrespective of the precision and so that the self-cleaning action at the connection time can be attained. Moreover, the rail connecting means of the rail elements 21 and 22 is disposed over the mechanical joint means of the layout elements so that the mechanical joint and the electric connection between the rail elements are simultaneously performed.

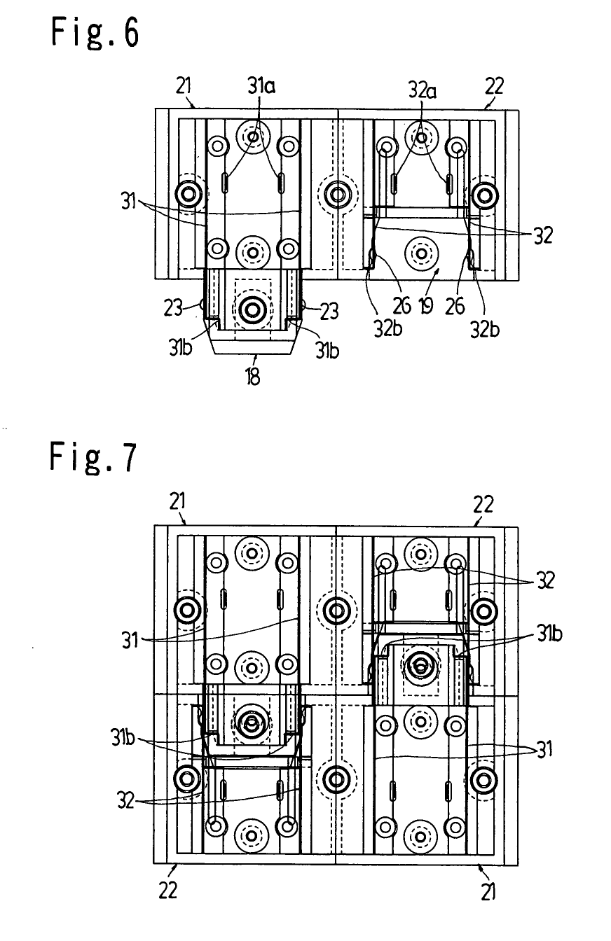

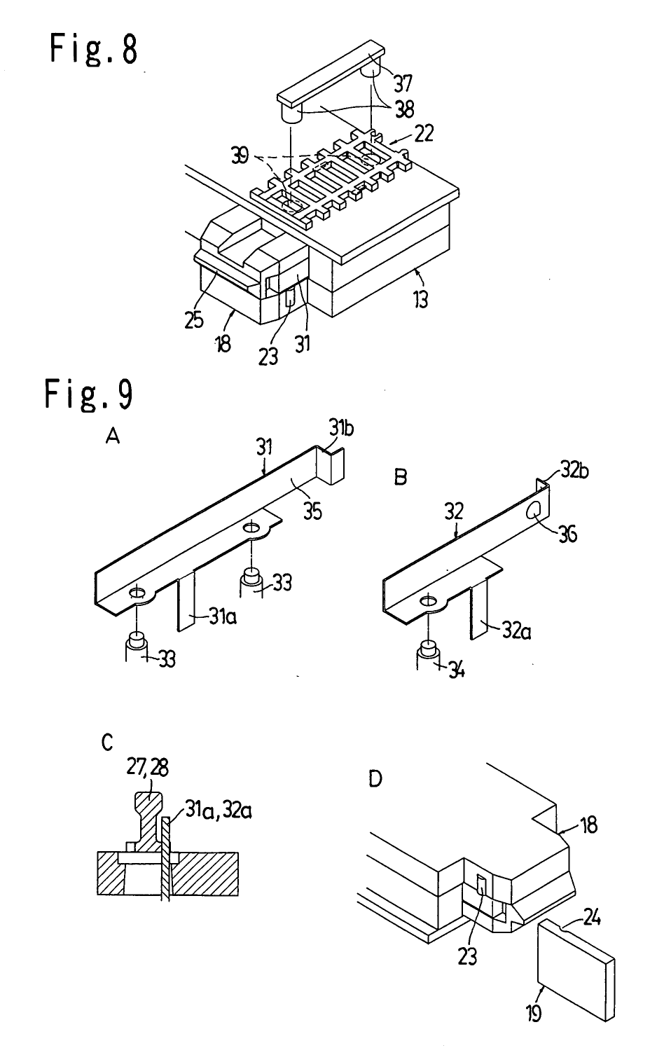

Here, the connection terminals 31 and 32 are equipped with hook-shaped leading ends 31b and 32b, one 31b of which engages with the leading end portion of the protrusion 18 and the other 32b of which engages with the leading end portion of the recess 19 (as referred to FIG. 6). In the structure of the shown case, the rail elements 21 and 22 are independent of the layout elements 11, 12 and 13 so that they are attached by means of a rail holder 37 (as referred to FIG. 8). Reference numeral 38 designates fitting legs, and numeral 39 designate fitting holes, both of them are disposed in the layout elements 11, 12 and 13. Here, the rail bases are made to engage with each other by engaging projections and depressions 21a and 22a disposed at the end portions (as referred to FIG. 3).

In the connecting device of the layout elements in the model train of the invention thus constituted, the layout elements 11, 12, 13 and so on independent of one another are connected by the mechanical joint means so that the model train can been joyed in an integrated large size. The layout elements 11, 12, 13 and so on are connected by bringing the connecting end portions 14, 15, 16, 17 and so on close to one another and by inserting the protrusions 18 protruding from the individual connecting end portions 14, 15, 16, 17 and soon, into the recesses 19 having the enclosing structure. As a result, the fitting actions of the three stages of: the fitting structures of the protrusions 18 and the recesses 19; the engagements between the protuberances 23 and the indentations 24; and the insertion-fitting structures of the projections 25 and the fitting portions 26 are performed to joint the layout elements 11, 12, 13 and so on mechanically completely.

Simultaneously with the mechanical joints between the aforementioned layout elements, moreover, the embossed portions 36 of the female connecting terminals 32 are connected while sliding with the electric terminals 35 on the outer side faces of the male connection terminals 31, so that the electric terminals 35 can move while polishing the contact portions 36, thereby to retain the electric connections. Therefore, it is possible to perform the mechanical joints and the electric connections of the rail elements simultaneously. For the disassembly after use, on the other hand, the layout elements 11, 12, 13 and so on may be separated from each other. This disassembly can be easily made on the principle of levers. Even if the layout elements 11, 12, 13 and so on then come into the state, in which they are folded from one another, the mechanical joint means is not broken by disengaging the leading end protrusions 25 and the fitting portions 26, no matter which of the upward or downward direction the fold might be made in.

In this railway layout according to the device of the invention, the mechanical joints of the layout elements 11, 12, 13 and so on and the connections of the electric circuits are carried out simultaneously with the connection of the rails 27 and 28, so that the layout is facilitated. Moreover, the railway layout is united as the layout elements 11, 12, 13 and so on equipped with the mechanical constitution and the electric constitution, so that only the units can be replaced when the railway layout is damaged.

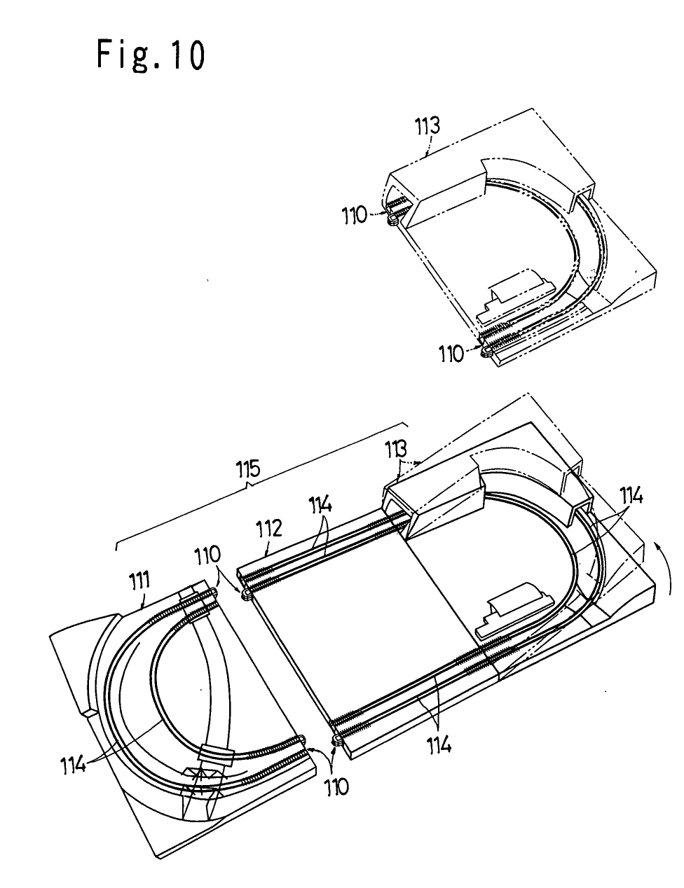

Next, a connecting device 110 for layout elements in a model train according to the invention is described in detail in connection with Embodiment 3. FIG. 10 shows the device 110 for feeding the electric power to rails 114 as an upper electric portion in the model train constituted of three layout elements 111, 112 and 113. The shown connecting device 110 is disposed at the connecting portions of the three layout elements 111, 112 and 113 constituting a layout 115.

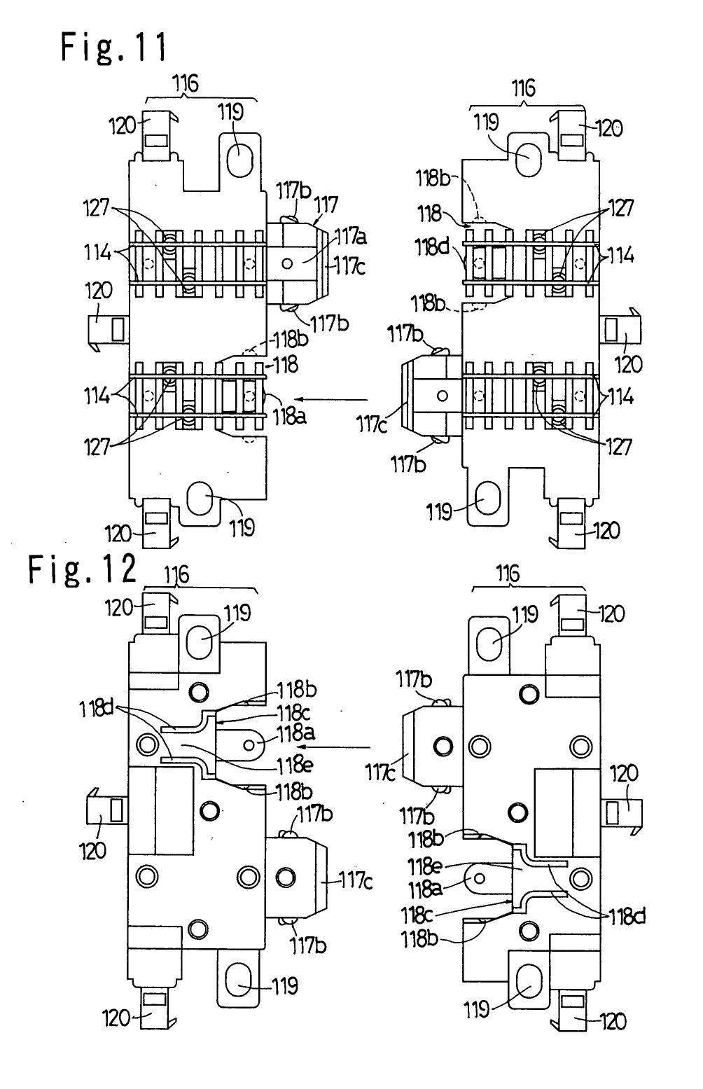

To the connecting portion of each of the layout elements 111, 112 and 113, there is attached a pair of two joint units 116, which are constituted by the so-called mating fitting structure. In the case of the shown device 110, the independent joint unit 116 is movably attached to the connecting end portions of the individual layout elements 111, 112 and 113. However, the present device 110 can be constituted without any trouble, even if the joint unit 116 is not movable. Each joint unit 116 is provided with a protrusion 117 shaped to protrude at the connecting end portion in the connecting direction, and a recess 118 enabled to fit the protrusion 117 by inserting the same in the protruding direction. Positioning means is provided at the protrusion 117 with a receiving groove 117a in the protruding direction, and at the recess 118 with a projection 118a for engaging with the receiving groove 117a. Reference should be made to FIG. 11 to FIG. 14.

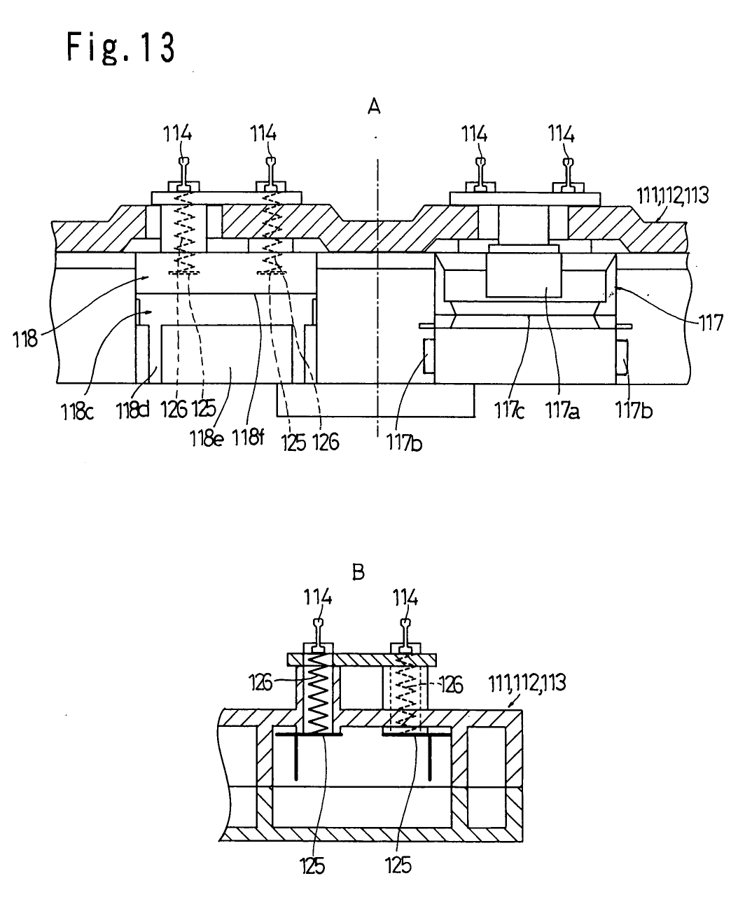

The aforementioned mating fitting structure plays roles to position the connections of the individual layout elements 111, 112 and 113 relative to each other and to bear the structural strength. This means for engaging to fix the last mating fit is equipped with protuberances 117b on the two right and left sides of the protrusion 117, and indentations 118b in the recess 118 for engaging with the protuberances 117b. For the vertical positioning, moreover, the protrusion 117 is equipped at its leading end with a protrusion 117c in the protruding direction, and deeply of the recess 118 with a recess 118c for receiving the protrusion 117c. The shown recess 118c is constituted an elastic member 118e enclosed by slits 118d and made vertically movable, and a fixing portion 118f, thereby to clamp and fix the inserted protrusion 117c elastically. Reference should be made to FIG. 12 and FIG. 13. The elastic member 118e, as enclosed by the slits 118d and made vertically movable, constitutes a relief portion, which allows the relief of the protrusion 117c fitted in the recess 118c.

The joint unit 116 thus far described is movably attached to the connecting end portion of each of the layout elements 111, 112 and 113. In the shown case, the joint unit 116 is provided at a plurality of attaching portions with slots 119 elongated in the transverse direction, so that it may swing to the right and left by not fastening but attaching stop screws 121 inserted into those slots 119. Reference numeral 120 designates three electric terminals for feeding the electricity to the two sets of rails and so on. Numeral 122 designate sheaths formed into a cylindrical shape to pass the stop screws 121 therethrough.

In the shown example, the two joint units 116 are disposed at the right and left portions of the connecting end portions of each of the layout elements 111, 112 and 113. In this case, both of the right and left joint units 116 may be movably attached to the right and left sides. However, it is apparent that the purpose can be achieved, if one joint unit 116 is made movable. By deciding one connection position precisely, specifically, the movement of the joint unit 116 can be absorbed even if an error exists in the other connection position, so that the troubles for the adjustment at the assembling time can be reduced. This adjustment at the assembling time can be applied to both the assemblies by the maker and the user at the using time.

The rails 114 are arranged over those individual layout elements 111, 112 and 113, and circuit wires 123 are arranged as lower electric feeding means below the rails 114. The circuit wires 123 are connected with any of the electric terminals 120. Leg portions 116a extending upward from the joint unit 116 are provided for arranging the rails 114 on the upper faces of the layout elements 111, 112 and 113. Reference should be made to FIG. 5. Moreover, electric connecting portions 124 and 125 are arranged on the side of the rails 114 and on the side of the circuit wires 123, respectively. In the shown example, no connecting portion is especially disposed on the side of the rails 114, but the lower face of the rails provides the connecting portions 124, with which the upper ends of intermediate electric portions 126 contact, the flat-shaped connecting portions 125 are disposed only on the side of the circuit wires 123.

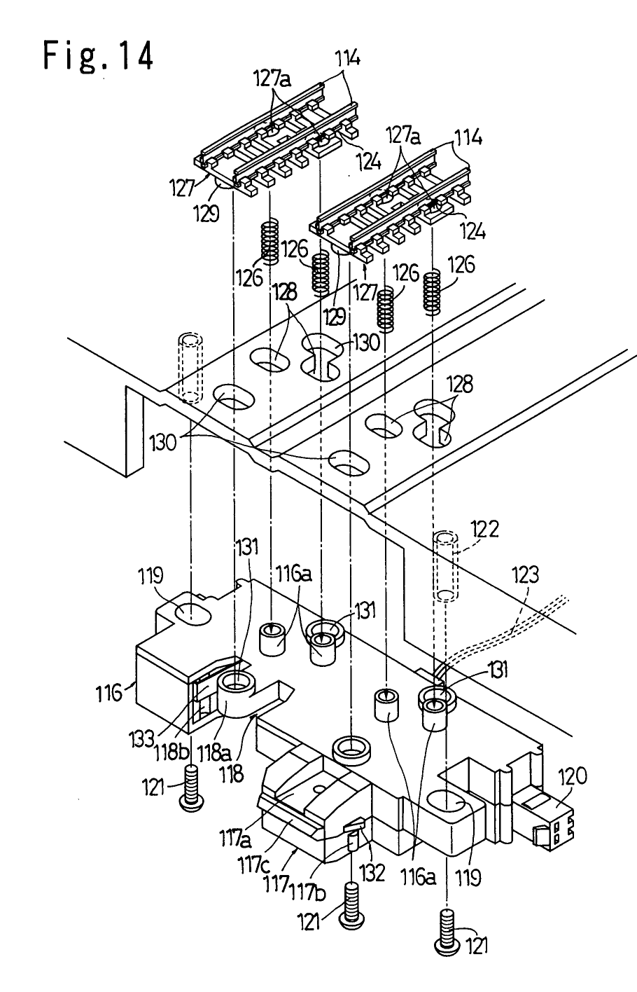

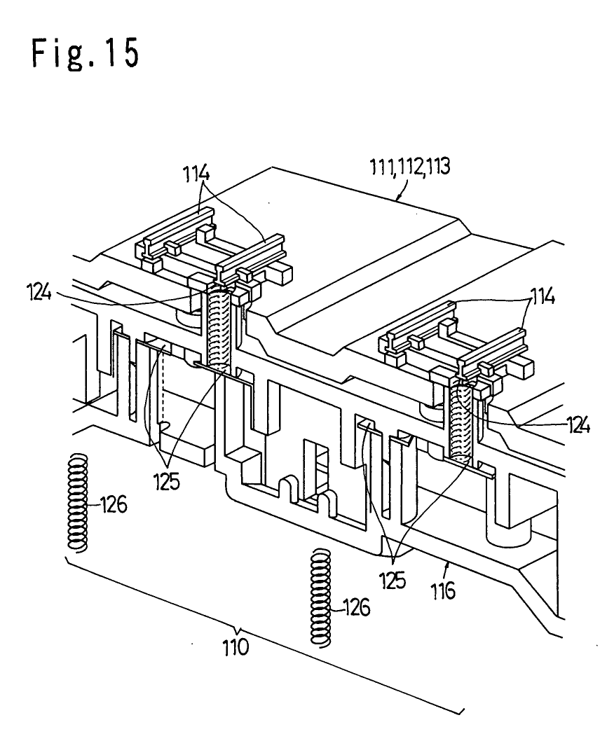

As shown in detail in FIG. 14 and FIG. 15, each joint unit 116 is integrally provided with the rails 114. Sleepers as a track bed portion 127 having the rails 114 attached thereto are provided with openings 127a, into which the aforementioned leg portions 116a are inserted. In the upper face of each of the layout elements 111, 112 and 113, there are formed slots 128, which are extended long in the transverse direction for passing the leg portions 116a therethrough, thereby to cope with the aforementioned adjustments at the assembling time. Reference numeral 129 designates a protrusion on the rail side, and a slot 130 is so formed in the upper face of the layout element as to pass through the protrusion 129. The aforementioned protrusion 129 is fitted in a fitting hole 131 on the joint unit side.

The aforementioned intermediate electric portions 126 are arranged in the aforementioned leg portions 116a so that they contact under pressure with the connecting portions 124 of the upper electric portion and the connecting portions 125 of the lower electric portion. The intermediate electric portions 126 are pressed to contact with the upper and lower connecting portions 124 and 125 thereby to ensure the electric connections reliably. The intermediate electric portions 126, as shown in FIG. 14, FIG. 15 and so on, are made of wound coils of a conductor, and have a larger natural length than the distance between the connecting portions 124 of the upper electric portion and the connecting portions 125 of the lower electric portion. The intermediate electric portions 126 are sandwiched under compression between the connecting portions 124 of the upper electric portion and the connecting portions 125 of the lower electric portion.

At the connecting end portions of each of the layout elements 111, 112 and 113 thus far described, the circuit wires are electrically connected with each other. For these connections, the protrusion 117 and the recess 118 are individually equipped (as referred to FIG. 14) with plus and minus terminals 132 and 133, which are connected with the connecting portions 125 of the circuit wires. In the shown example, the terminals 132 of a leaf spring shape are disposed on the two right and left sides of the protrusion 117, and the terminals 133 of a leaf spring shape are disposed on the two right and left sides of the recess 118.

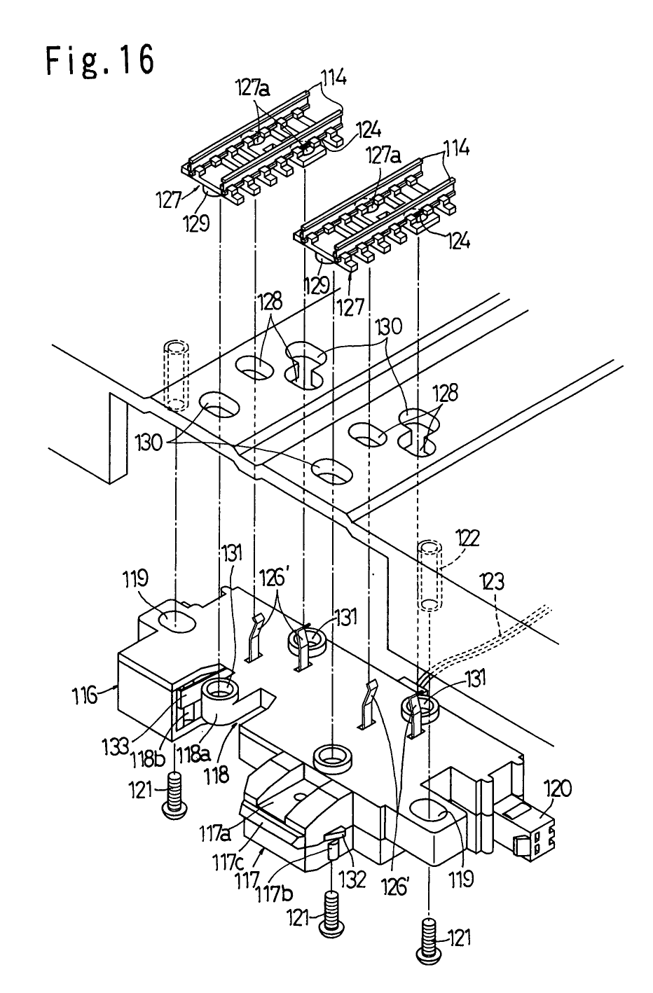

FIG. 16 shows a modification using conductive members of a leaf spring shape as the intermediate electric portions. Intermediate electric portions 126′ of the modification are pressed to contact with the side faces of the rails 114, and are connected at their other ends with the aforementioned connecting portions 125 or electric terminals 120 at a plurality of portions. The remaining constitutions of the modification may be similar to those of the example of FIG. 14, and their detailed description is omitted by referring to the reference numerals.

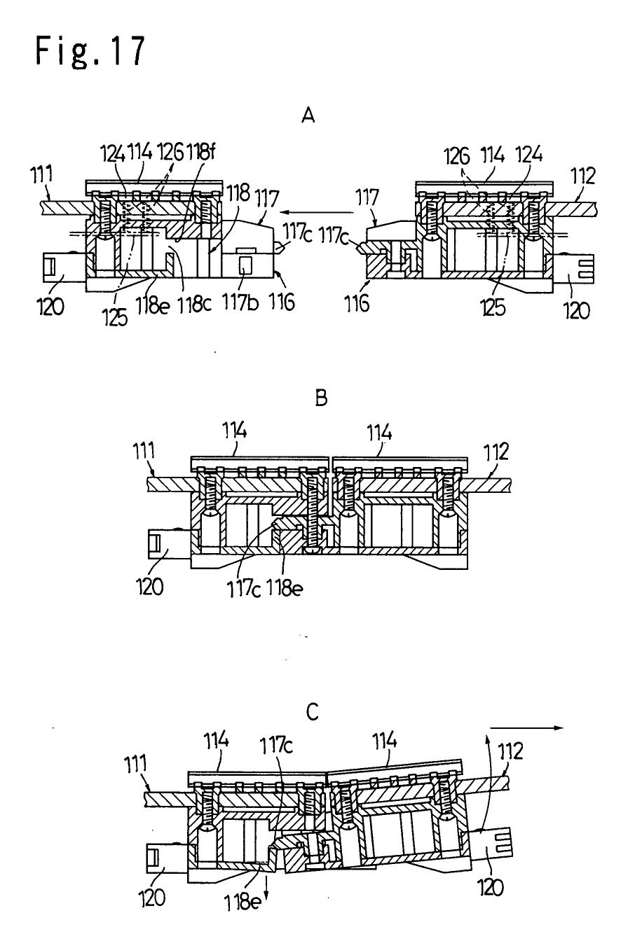

The connecting device 110 of the layout elements in the model train according to the invention is constituted, as has been described hereinbefore. In the layout of the model train composed of the layout elements 111, 112 and 113, the connecting end portions are registered by arranging the individual layout elements 111, 112 and 113 substantially horizontally (FIG. 17A), and the joint units 116 are jointed to assemble the entirely integral layout 115. At this time, the joint units 116 are mechanically jointed by engaging the receiving grooves 117a and the projections 118a, and the protuberances 117b and the indentations 118b, and by fitting the protrusions 117c and the recesses 118c. Simultaneously with this, the terminals 132 and 133 are brought to contact with each other to cause the electric connections (FIG. 17B). As a result, the rails 114 and lamps can be energized, so that the model train can run. In order to disassemble the individual layout elements 111, 112 and 113 jointed, the end portion of one layout element (i.e., the end portion of the layout element 113 in FIG. 10) at the connecting end portion is lifted (FIG. 17C), and is folded on the connecting end portion. As a result, when the protrusion 117c leaves the recess 118c, the protuberances 117b and the indentations 118b are disengaged so that the layout elements can be separated easily and reliably. At this time, the protrusion 117c comes out while pressing down the elastic member 118e and smoothly leaves, so that no damage occurs even if the attachment and detachment are repeated.

The reliable electric connections can be ensured by the contact pressure of the intermediate electric portion 126. Each of the layout elements 111, 112 and 113 is connected by the joint unit 116 movably attached thereto. Even if, therefore, the position of the intermediate electric portion is offset from the position of the electric connecting portion 124 of the electric portion or the connecting portion 125 of the circuit wire, the connecting portions 124 and 125 of the electric portions slide, when moved to absorb the offset, with respect to the intermediate electric portion 126 so that their electric connections are kept to exclude the adverse affections. Moreover, the mechanical and electric connections can be made both at once so that the electric power can be reliably fed to the electric portions including the rails 114.

What is claimed is:

1. In a layout of a model train, in which rail elements including straight, curved and terminal elements are laid on layout bases to form layout elements, and in which the layout elements are connected to constitute a predetermined running line,
a connecting device for the layout elements in the model train, characterized:
in that a layout integrated by mechanical joint means composed of mutually fitting recess and protrusion is constituted at the connecting end portions of the layout elements; and
in that the rail elements are connected by rail connecting means disposed at a predetermined position of the layout elements whereas the layout elements are jointed by said joint means so that the rail elements are also electrically connected with each other.

2. A connecting device for layout elements in the model train, according to claim 1,
wherein the mechanical joint means of the layout elements and the rail connecting means of the rail elements are overlapped at a common portion of the layout elements,
wherein said joint means of the layout elements includes: protrusions shaped to protrude with a larger width than that of the two rails from the connecting end portions of the layout elements; recesses shaped to fit said protrusions; and engaging portions on the side faces of said protrusions and said recesses for engaging with each other at the fitting time of said joint means thereby to prevent the fitting engagements from being released, and
wherein the rail elements are constructed to bring the connecting end portions of the two rails constituting a single line into abutment against each other, and to use connection terminals for electric connections, which have a constitution to contact at point contacts.

3. A connecting device for layout elements in the model train, according to claim 2,
wherein the protrusions shaped to protrude from the connecting end portions and the recesses shaped to fit said protrusions are formed in each of lines constituted of a double track, and are constituted such that said protrusions are formed at one single track constituting the double track whereas said recesses for fitting said protrusions are formed at the other single track constituting the same double track.

4. In a model train including: a plurality of layout elements; mechanical joint means for combining the layout elements integrally to connecting the individual layout elements; and electric connecting means for the conductive portions containing rails of the layout elements electrically,
a connecting device for layout elements in a model train, characterized: in that each of the layout elements includes such a pair of joint units as said joint means as are disposed at the individual connecting end portions and as can be jointed to and separated from each other; and in that the joint units are provided with: engaging portions and engaging partners adapted to be connected by causing the layout elements to engage with each other; protrusions and recesses enabled to be fitted for positioning; and relief portions for allowing the relief of the protrusions fitted in the recesses, so that the engaging portions and the engaging partners may leave each other, by turning to fold, when the joint units are in the jointed state, the end portions of one of the layout elements on the connected portions with respect to the other layout element.

5. A connecting device for the layout elements in the model train, according to claim 4, wherein the relief portions are either cavities forming the recesses fitting the protrusions and having their upper and lower and right and left portions partially removed, or elastic members having their upper and lower and right and left portions made elastically deformable.

6. A connecting device for the layout elements in the model train, according to claim 4, wherein the electric connecting means includes an upper electric portion having the rails disposed over the layout element, and a lower electric portion arranged below the former, and wherein the upper electric portion and the lower electric portion are connected by an intermediate electric material made of a conductor and having an elasticity.
